(19) United States
(12) Patent Application Publication
(10) Pub. No.: US 2023/0368593 A1
(43) Pub. Date: Nov. 16, 2023

(54) BLUETOOTH INTELLIGENT UNLOCKING METHOD, APPARATUS, DEVICE AND STORAGE MEDIUM

(71) Applicant: HOLITECH TECHNOLOGY AMERICA, INC., Santa Clara, CA (US)

(72) Inventors: Xiaobing MAO, Santa Clara, CA (US); Songjin YAO, Santa Clara, CA (US); Lun WANG, Santa Clara, CA (US)

(73) Assignee: HOLITECH TECHNOLOGY AMERICA, INC., Santa Clara, CA (US)

(21) Appl. No.: 17/743,809

(22) Filed: May 13, 2022

(51) Int. Cl. G07C 9/00; H04M 1/72457; H04M 1/72412; H04W 8/00; H04W 4/02

(52) U.S. Cl. CPC G07C 9/00309; H04M 1/72457; H04M 1/72412; H04W 8/005; H04W 4/023; G07C 2209/63; G07C 2009/00317

(57) ABSTRACT

Disclosed are a Bluetooth intelligent unlocking method, an apparatus, a device and a storage medium. The method includes: scanning terminal devices within a preset range based on a Bluetooth signal, and determining whether there is a terminal device according to a scanning result; in responding to that there is a terminal device, obtaining device information of the terminal device and verifying the device information; in responding to that the device information is validated, unlocking a Bluetooth lock upon receiving an unlocking command triggered based on a preset key; further, when there is the terminal device within the preset range, the present application unlocks the Bluetooth intelligent lock based on the unlocking command triggered by the preset key, so that the user does not need to unlock through the app of the mobile phone to improve the user experience.

### TECHNICAL FIELD

The present application relates to a technical filed of information security, in particular to a Bluetooth intelligent unlocking method, a Bluetooth intelligent unlocking apparatus, a Bluetooth intelligent unlocking device and a storage medium.

### BACKGROUND

At present, with the gradual maturity of Bluetooth technology, smart locks in the market adopt Bluetooth unlocking mode. Bluetooth smart locks are equipped with a corresponding app of the mobile phone. When the user unlocks, the Bluetooth of the mobile phone is connected with the Bluetooth smart lock, and then the app of the mobile phone is used to control unlocking.

However, in the related art, when the user needs to unlock, he must first open the mobile phone to find the corresponding app, and then unlock. Then, it takes a long time to unlock through the app of the mobile phone, especially when it is inconvenient for the user to operate the mobile phone with both hands, the unlocking is cumbersome and the user experience is poor.

The above content is only used to assist in understanding the technical solution of the present application, and does not mean that the above content is the related art.

### SUMMARY

The main purpose of the present application is to provide a Bluetooth intelligent unlocking method, an apparatus, a device and a storage medium, which aims to solve the technical problems of long time-consuming and cumbersome unlocking process.

In order to achieve the above purpose, the present application provides a Bluetooth intelligent unlocking method, including:
scanning terminal devices within a preset range based on a Bluetooth signal, and determining whether there is a terminal device according to a scanning result;
in responding to that there is a terminal device, obtaining device information of the terminal device and verifying the device information; and
in responding to that the device information is validated, unlocking a Bluetooth lock upon receiving an unlocking command triggered based on a preset key.

Optionally, the operation of obtaining the device information of the terminal device and verifying the device information includes:
obtaining the device information of the terminal device; and
verifying whether the device information belongs to a device information database, wherein the device information database stores device information of paired terminal devices within a preset time period.

Optionally, the operation of after the obtaining the device information of the terminal device and verifying the device information, the method further includes:
in responding to that the device information does not belong to the device information database, receiving a Bluetooth pairing request of the terminal device based on the Bluetooth signal;
obtaining a pairing password carried by the Bluetooth pairing request and verifying the pairing password; and
in responding to that the pairing password is validated, establishing a Bluetooth connection with the terminal device, and storing the device information of the terminal device in the device information database.

Optionally, the operation of the in responding to that the pairing password is validated, establishing the Bluetooth connection with the terminal device and storing the device information of the terminal device into the device information database, the method includes:
establishing the Bluetooth connection with the terminal device and obtaining the device information of the terminal device in responding to that the pairing password is verified as a preset password;
obtaining a number of pieces of device information in the device information database; and
storing the device information of the terminal device in the device information database in responding to that the number does not exceed a preset number.

Optionally, after the operation of the obtaining the number of pieces of device information in the device information database, the method further includes:
obtaining a storing timestamp corresponding to each piece of device information in the device information database in responding to that the number reaches the preset number;
determining earliest stored device information according to an order of storing timestamps; and
replacing the earliest stored device information with the device information of the terminal device.

Optionally, the operation of in responding to that the device information is validated, unlocking the Bluetooth lock upon receiving the unlocking command triggered based on the preset key, includes:
in responding to that the device information is validated, determining whether a distance between the Bluetooth lock and the terminal device exceeds a preset distance based on the Bluetooth signal; and
in responding to that the distance does not exceed the preset distance, unlocking the Bluetooth lock upon receiving the unlocking command triggered based on the preset key.

Optionally, after an operation of in responding to that the device information is validated, determining whether the distance between the Bluetooth lock and the terminal device exceeds the preset distance based on the Bluetooth signal, the method further includes:
in responding to that the distance exceeds the preset distance, sending confirmation information to the terminal device for unlocking confirmation according to the unlocking command; and
upon receiving confirmation information fed back by the terminal device, unlocking the Bluetooth lock based on the unlocking command triggered by the preset key.

In addition, in order to achieve the above purpose, the present application provides a Bluetooth intelligent unlocking device, including:
a scanning module for scanning a terminal device based on a Bluetooth signal within a preset range, and determining whether there is the terminal device according to a scanning result;
an information verification module for obtaining device information of the terminal device and verifying the device information when there is the terminal device; and
a control unlocking module for unlocking when receiving an unlocking command triggered based on a preset key when the verification is passed.

In addition, in order to achieve the above purpose, the present application provides a Bluetooth intelligent unlocking device, including a memory, a processor and a Bluetooth intelligent unlocking program stored on the memory and running on the processor; the Bluetooth intelligent unlocking program is configured to realize steps of the Bluetooth intelligent unlocking method as mentioned above.

In addition, in order to achieve the above purpose, the present application provides a storage medium, on which a Bluetooth intelligent unlocking program is stored; when the Bluetooth intelligent unlocking program is executed by the processor, steps of the Bluetooth intelligent unlocking method as mentioned above are realized.

In the present application, the terminal device are scanned based on the Bluetooth signal within a preset range, and whether there is the terminal device according to the scanning result is determined; device information of the terminal device is obtained and the device information is verified when there is the terminal device; when the verification is passed, it is unlocked when receiving the unlocking command triggered based on a preset key; further, when there is the terminal device within the preset range, the present application unlocks based on the unlocking command triggered by the preset key, so that the user does not need to unlock through app of the mobile phone to improve the user experience.

### BRIEF DESCRIPTION OF THE DRAWINGS

FIG. 1 is a structural diagram of a Bluetooth intelligent unlocking device in a hardware operation environment related to embodiments of the present application.

FIG. 2 is a flow diagram of a first embodiment of a Bluetooth intelligent unlocking method of the present application.

FIG. 3 is a flow diagram of a second embodiment of the Bluetooth intelligent unlocking method of the present application.

FIG. 4 is a flow diagram of a third embodiment of the Bluetooth intelligent unlocking method of the present application.

FIG. 5 is a structural block diagram of a first embodiment of a Bluetooth intelligent unlocking apparatus of the present application.

The realization of the purpose, functional features and advantages of the present application will be further described with reference to the attached drawings in combination with the embodiment.

### DETAILED DESCRIPTION OF THE EMBODIMENTS

It should be understood that the specific embodiments described herein are only used to explain the present application and are not used to limit the present application.

Referring to FIG. 1, FIG. 1 is a structural diagram of a Bluetooth intelligent unlocking device in a hardware operation environment according to an embodiment of the present application.

As shown in FIG. 1, the Bluetooth intelligent unlocking device can include: a processor 1001, such as a central processing unit (CPU), a communication bus 1002, a user interface 1003, a network interface 1004 and a memory 1005. The communication bus 1002 is configured to realize the connection and communication among these components. The user interface 1003 may include a display and an input unit, such as a keyboard. The user interface 1003 may optionally include a standard wired interface and a wireless interface. The network interface 1004 may optionally include a standard wired interface and a wireless interface (such as a Wireless-Fidelity (Wi-Fi) interface). The memory 1005 may be a high-speed random access memory (RAM) or a stable non-volatile memory (NVM), such as a disk memory. The memory 1005 may optionally be a storage device independent of the aforementioned processor 1001.

Those skilled in the art can understand that the structure shown in FIG. 1 does not constitute a limitation on the Bluetooth intelligent unlocking device, which may include more or fewer components than shown in the figure, or a combination of some components, or different component arrangements.

As shown in FIG. 1, the memory 1005 as a storage medium may include an operation system, a network communication module, a user interface module and a Bluetooth intelligent unlocking program.

In the Bluetooth intelligent unlocking device shown in FIG. 1, the network interface 1004 is mainly configured for data communication with a network server. and the user interface 1003 is mainly configured for data interaction with users. The processor 1001 and memory 1005 in the Bluetooth intelligent unlocking device of the present application can be provided in the Bluetooth intelligent unlocking device. The Bluetooth intelligent unlocking device calls the Bluetooth intelligent unlocking program stored in the memory 1005 through the processor 1001 and executes a Bluetooth intelligent unlocking method provided by the embodiment of the present application.

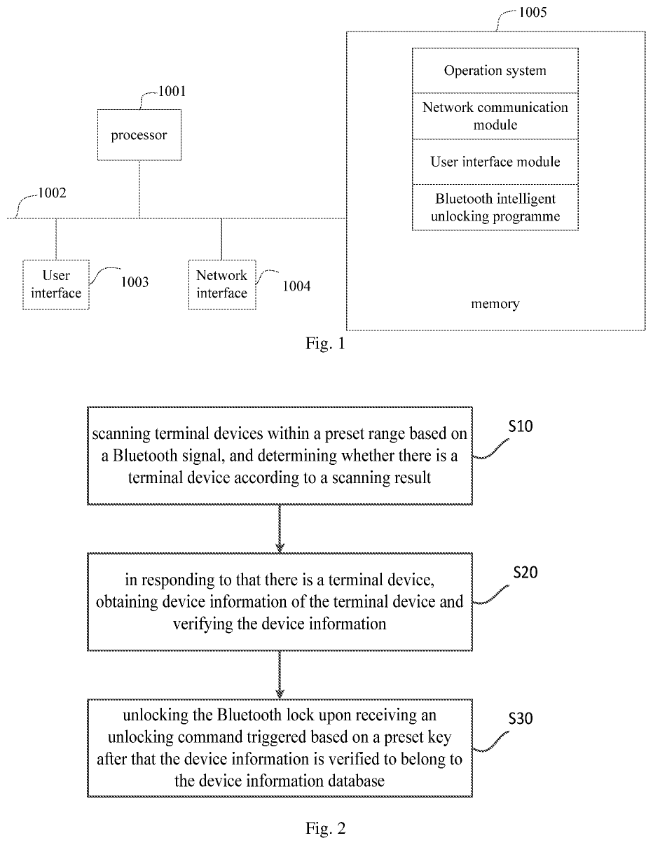

The embodiment of the present application provides a Bluetooth intelligent unlocking method. Referring to FIG. 2, FIG. 2 is a flow diagram of a first embodiment of the Bluetooth intelligent unlocking method of the present application.

In this embodiment, the Bluetooth intelligent unlocking method includes:

Operation S10, scanning terminal devices within a preset range based on a Bluetooth signal, and determining whether there is a terminal device according to a scanning result.

It should be noted that the Bluetooth intelligent unlocking method provided in this embodiment can be applied to a scene of using Bluetooth technology for lock and unlock. The executive body of the method of this embodiment can be a Bluetooth lock that can use the Bluetooth communication technology to unlock or lock, or another door lock device that can realize the same or similar function. Here, the Bluetooth intelligent unlocking method provided in this embodiment and the following embodiments is described in detail with the above Bluetooth intelligent lock (hereinafter referred to as the Bluetooth lock).

It is understandable that a Bluetooth module can be set inside the Bluetooth lock of this embodiment and can be a traditional Bluetooth module or a low-power Bluetooth module. In order to further save power, this embodiment adopts the low-power Bluetooth module for description.

It should be understood that the above preset range can be a broadcast range of the Bluetooth signal broadcast by the Bluetooth module, and the above range can be set by the user according to the actual situation.

It should be noted that in order to facilitate the power supply to the Bluetooth lock, the Bluetooth lock can be directly powered by external or by a rechargeable battery. When the power is insufficient, the user can charge the rechargeable battery, or other batteries that can be applied to the Bluetooth lock can be used.

It should be explained that the above terminal device can be a smart phone, a tablet, a smart bracelet/watche, etc., or another portable smart device that can be configured to receive Bluetooth signals broadcasted by the Bluetooth lock. At the same time, the above terminal device can also be installed with an app corresponding to the Bluetooth lock of this embodiment, and the users can also unlock through the app.

Further, in order to prevent the user from forgetting to carry the terminal device for unlocking, the Bluetooth lock can also be unlocked by password, and a password key can be set on the Bluetooth lock.

In the specific implementation, the Bluetooth lock controls the Bluetooth module to be in a low-power broadcasting state within the preset range. The Bluetooth lock scans based on the Bluetooth signal to determine whether there is a terminal device within the preset range. Of course, it is on the premise that the Bluetooth module of the terminal device is turned on.

Operation S20, in responding to that there is a terminal device, obtaining device information of the terminal device and verifying the device information.

It should be noted that the above terminal device can be a device which receives the Bluetooth signal successfully, and the above device information can be a LAN address (Media Access Control Address), a personal identification number (PIN code) of the terminal device, or other information that can be configured to indicate the uniqueness of the terminal device.

It should be emphasized that the Bluetooth lock is also provided with a prompt module for prompting a connection status to the user. The prompt module can be an indicator light or another module that can be configured for prompt. The prompt module of the Bluetooth lock in this embodiment is an indicator light. During the scanning of the Bluetooth lock for devices, that is, when the Bluetooth module is in a low-power broadcasting state, the indicator light blinks slowly and regularly. When the Bluetooth lock is successfully connected with the terminal device, the indicator light is always on. After the Bluetooth lock completes the unlocking, the indicator light is turned off, which is conducive to the user to know the working state of the Bluetooth lock in real time.

Further, in order to improve the security of the Bluetooth lock, in this embodiment, the operation of obtaining the device information of the terminal device and verifying the device information includes:
obtaining the device information of the terminal device; and
verifying whether the device information belongs to a device information database, where the device information database stores device information of terminal devices successfully paired with the Bluetooth within a preset time period.

It should be noted that the Bluetooth lock in this embodiment is associated with a device information database, which can be stored in the memory internal of the Bluetooth lock. The device information database stores the device information of the terminal devices successfully paired with the Bluetooth lock in a preset time period. The preset pairing time period can be set by the user. For example, the user sets the preset pairing time period as 3 days, then the Bluetooth lock can only store the device information of the terminal devices paired successfully within 3 days, so as to improve the security of the Bluetooth lock.

In the specific implementation, when the Bluetooth lock is not scanned by the terminal device within the preset range, it indicates that there is no terminal device within the preset range. At this time, the indicator of the prompt module flashes slowly at a certain time interval. If the Bluetooth lock is scanned by the terminal device within the preset range, it indicates that there is a terminal device within the preset range, and the Bluetooth lock can obtain the device information of the above terminal device, and then verify whether the device information belongs to the device information database.

Operation S30, unlocking the Bluetooth lock upon receiving an unlocking command triggered based on a preset key after that the device information is verified to belong to the device information database.

It should be noted that the above unlocking command can be triggered based on the preset key, which is triggered by executing the corresponding operation when the user has the unlocking demand. In this embodiment, the unlocking key can be set on the Bluetooth lock, and the user can issue the unlocking command by touching an unlocking button. The corresponding operations include but are not limited to: pressing a handle of the Bluetooth lock, touching the unlocking button, rotating the unlocking button, etc.

It is understandable that after the above Bluetooth lock is opened, a current opening time and the device information of the terminal device can also be uploaded to a server, and the user can view an opening record of the Bluetooth lock through the app to further improve the security.

In the specific implementation, when the device information of the terminal device belongs to the device information database of the Bluetooth lock, the prompt light of the prompt module changes to be always on. The user can touch the preset key on the Bluetooth lock to trigger the unlocking command, and then the Bluetooth lock is adjusted to be an unlocked state.

In this embodiment, the Bluetooth lock controls the Bluetooth module to be in the low-power broadcasting state within the preset range, and the Bluetooth lock scans based on the Bluetooth signal to determine whether there is a terminal device within the preset range. When the Bluetooth lock is not scanned by the terminal device within the preset range, it indicates that there is no terminal device within the preset range. At this time, the indicator of the prompt module flashes slowly at a certain time interval. If the Bluetooth lock is scanned by the terminal device within the preset range, it indicates that there is a terminal device within the preset range, and the Bluetooth lock can obtain the device information of the above terminal device, then whether the device information belongs to the device information database is verified based on the device information database. When the device information of the terminal device belongs to the device information database of the Bluetooth lock, the prompt light of the prompt module changes to be always on. The user can touch the preset key on the Bluetooth lock to trigger the unlocking command, and then the Bluetooth lock is adjusted to the unlocked state. Thus, when there is a terminal device within the preset range, the Bluetooth lock is unlocked based on the unlocking command triggered by the preset key in the present application, and the user does not need to control the unlocking through the app of the mobile phone and the user experience is improved.

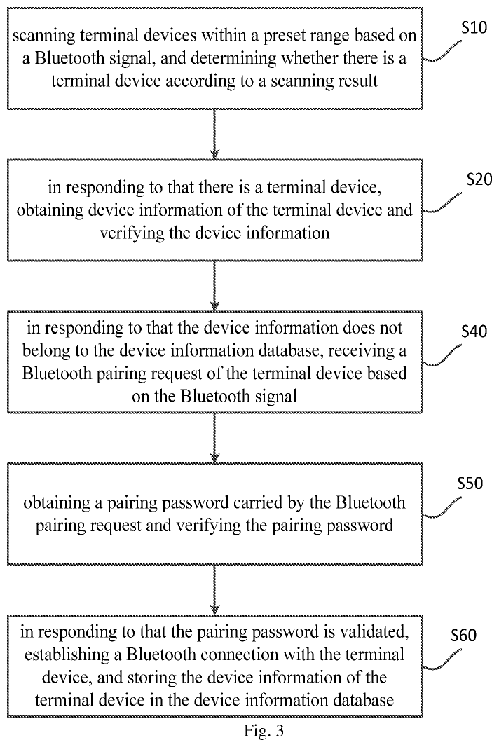

Referring to FIG. 3, FIG. 3 is a flow diagram of a second embodiment of the Bluetooth intelligent unlocking method of the present application.

Based on the above first embodiment, in this embodiment, after the operation S30, the method further includes:

Operation S40, in responding to that the device information does not belong to the device information database, receiving a Bluetooth pairing request of the terminal device based on the Bluetooth signal.

It should be noted that the above Bluetooth pairing request can be realized by that the user views a pairing list through the mobile phone, selects a Bluetooth device name corresponding to the above Bluetooth lock according to the pairing list, and clicks the Bluetooth device name.

In the specific implementation, considering that the Bluetooth lock needs to add a paired device, when determining that the device information of the above terminal device does not belong to the device information database, the user can click the Bluetooth device name corresponding to the Bluetooth lock in the pairing list, which indicates that the terminal device has a pairing requirement at this time.

Operation S50, obtaining a pairing password carried by the Bluetooth pairing request and verifying the pairing password.

It should be noted that the above pairing password can be obtained according to feedback of a pairing window popped up on the above terminal device. Accordingly, there is a preset password stored in the Bluetooth lock. The preset password can be the PIN code set by the manufacturer when the Bluetooth lock leaves the factory, or set by users themselves during use. This embodiment is not limited to this.

In the specific implementation, when the user clicks the Bluetooth device name corresponding to the Bluetooth lock in the pairing list, the pairing window can be popped up on the display screen of the terminal device. The pairing window can be configured for the user to enter the pairing password. After the user enters the pairing password, the terminal device sends the pairing password to the Bluetooth lock for verification.

Operation S60, in responding to that the pairing password is validated, establishing a Bluetooth connection with the terminal device, and storing the device information of the terminal device in the device information database.

In the specific implementation, if the pairing password input by the user is the preset password, the terminal device will establish a connection with the Bluetooth lock, and send the device information of the terminal device to the device information database of the Bluetooth lock for storing.

Further, in order to improve the operation efficiency of the Bluetooth lock, the amount of the device information stored in the device information database can have a certain upper limit. In this embodiment, it can be realized as follows: in responding to that the pairing password is verified as a preset password, establishing a Bluetooth connection with the terminal device and obtaining the device information of the terminal device; and obtaining a number of pieces of device information in the device information database.

In the specific implementation, after verifying that the pairing password is the preset password, the Bluetooth lock obtains the device information of the above terminal device, and also obtain the number of pieces of device information stored in the information base.

When the number of pieces of device information does not exceed a preset number, the device information of the terminal device is stored in the device information database.

It is understandable that the above preset number can be set according to the actual storage capacity of the device information database.

In the specific implementation of this embodiment, when the number of pieces of device information stored in the information base does not exceed the preset number, it means that at the current time, the device information database can store more device information, and the Bluetooth lock stores the device information of the above terminal device in the device information database.

Further, in order to save hardware space and improve the operation efficiency of the Bluetooth lock, after the above operation of obtaining the number of pieces of device information in the device information database, the method further includes:
obtaining a storing timestamp corresponding to each piece of device information in the device information database in responding to that the number reaches the preset number.

It should be noted that when storing the device information of the terminal device, the Bluetooth lock can store the storing timestamp corresponding to the device information at the same time. The device information in the device information database can be sorted according to the corresponding storing timestamps. The sorting method can be that the earlier a storing timestamp is, the more forward the storing timestamp will be, or the later a storing timestamp is, the more forward the storing timestamp will be, which is helpful for finding the Bluetooth lock.
determining the earliest stored device information according to an order of storing timestamps; and
replacing the earliest stored device information with the device information of the terminal device.

It should be noted that the above earliest stored device information can be the device information with the earliest time stamp stored in the device information database. For example, device information A, device information B and device information C are stored in the device information database. The storing timestamp corresponding to device information A is time 1, the storing timestamp corresponding to device information B is time 2, the storing timestamp corresponding to device information C is time 3. Time 1 is earlier than time 2, time 2 is earlier than time 3, and the preset number set by the user is 3. At this time, the device information of the new terminal device is device information D. When the Bluetooth lock stores the device information D in the device information database, because the device information database is full, the Bluetooth lock can delete the device information A corresponding to time 1 with the earliest storing time, store the device information D in the device information database, and record the storing timestamp as time 4.

In the specific implementation, when a number of the device information in the device information database reaches the preset number, the Bluetooth lock can obtain the storing timestamp corresponding to each device information in the device information database, select the initially stored device information in the device information database according to the storing timestamp, and replace the initially stored device information with the device information of the above terminal device, so as to improve the operation efficiency and improve the security at the same time.

In this embodiment, considering that the Bluetooth lock needs to add a paired device, upon determining that the device information of the above terminal device does not belong to the device information database, the user can click the Bluetooth device name corresponding to the Bluetooth lock in the pairing list, which indicates that the terminal device has a pairing requirement at this time. At the same time, a pairing window can be popped up on the display screen of the terminal device for the user to input the pairing password. After the user inputs the pairing password, the terminal device sends the pairing password to the Bluetooth lock for verification. After it is verified that the pairing password is the preset password, the Bluetooth lock obtains the device information of the above terminal device, and obtains the number of pieces of device information stored in the information base. When the number of device information stored in the information base does not exceed the preset number, it means that the device information database can store more device information at this time, and the Bluetooth lock stores the device information of the terminal device in the device information database. When the number of device information in the device information database reaches the preset number, the Bluetooth lock can obtain the storing timestamp corresponding to each piece of device information in the device information database, select the earliest stored device information in the device information database according to the storing timestamp, and replace the earliest stored device information with the device information of the above terminal device. The operation efficiency and the security are both improved.

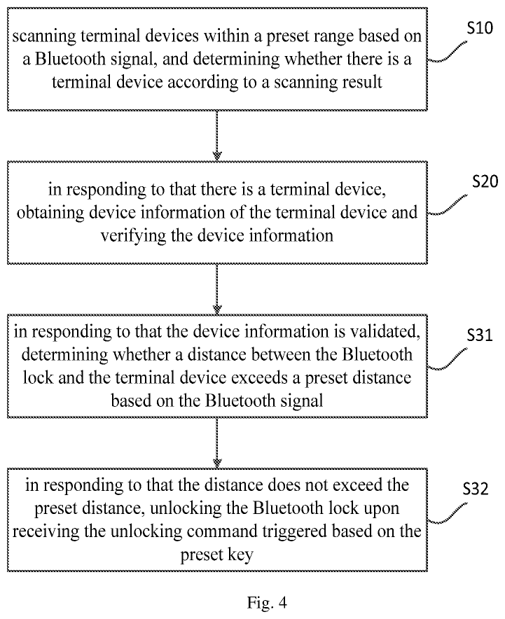

Referring to FIG. 4, FIG. 4 is a flowchart of a third embodiment of the Bluetooth intelligent unlocking method of the present application.

As shown in FIG. 4, in this embodiment, in order to prevent the Bluetooth lock from being opened by others when the terminal device is far away from the Bluetooth lock, and further improve the security, the above operation S30 includes:

Operation S31, in responding to that the device information is validated, determining whether a distance between the Bluetooth lock and the terminal device exceeds a preset distance based on the Bluetooth signal.

It should be noted that the Bluetooth lock can also determine the distance between the Bluetooth lock and the terminal device according to the strength of the Bluetooth signal. If the distance between the terminal device and the Bluetooth lock is closer, the Bluetooth signal is stronger. If the distance between the terminal device and the Bluetooth lock is farther, the Bluetooth signal is weaker.

It is understandable that the above preset distance can be within the preset broadcast range of the Bluetooth, and the preset distance can be set by the user according to the actual situation.

Operation S32, in responding to that the distance does not exceed the preset distance, unlocking the Bluetooth lock upon receiving the unlocking command triggered based on the preset key.

It should be noted that, for example, the above preset range is 5 m, and the user can set the preset distance as 1 m. When the terminal device is 4 m from the Bluetooth lock, the Bluetooth lock has been scanned by the terminal device, and the Bluetooth lock verifies the terminal device. When the verification is passed, the distance between the terminal device and the Bluetooth lock is monitored in real time. If the distance between the terminal device and the Bluetooth lock is reduced to 0.5 m, the Bluetooth lock unlocks upon receiving the unlocking command triggered based on the preset key.

Further, in order to prevent the Bluetooth lock from being opened by others when the terminal device is far away from the Bluetooth lock, in this embodiment, after operation S31, the method further includes: in responding to that the distance exceeds the preset distance, sending confirmation information to the terminal device for unlocking confirmation according to the unlocking command.

It should be noted that the above confirmation information can be the information generated by the Bluetooth lock to determine whether it is the user's own unlocking requirement. In this embodiment, the above confirmation information can be a confirmation window.

Unlocking based on the unlocking command triggered by the preset key upon receiving the confirmation information fed back by the terminal device.

It can be understood that, for example, the above preset range is 5 m, and the user can set the preset distance as 1 m. When the terminal device is 4 m from the Bluetooth lock, the Bluetooth lock has been scanned by the terminal device, and the Bluetooth lock monitors the distance between the terminal device and the Bluetooth lock in real time. If the distance between the terminal device and the Bluetooth lock is reduced to 2 m, and the Bluetooth lock receives the unlocking command triggered based on the preset key, it can be considered that the unlocking command is not triggered by the user himself. At this time, the Bluetooth lock can send a confirmation window to the user's terminal device for confirmation. After the user confirms through the terminal device, the Bluetooth lock unlocks based on the unlocking command triggered by the preset key.

In the specific implementation, after the terminal device passes the verification, the Bluetooth lock can determine the distance from the terminal device based on the Bluetooth signal. When the above distance does not exceed the preset distance, the Bluetooth lock will unlock upon receiving the unlocking command triggered based on the preset key. When the above distance exceeds the preset distance, the Bluetooth lock can send confirmation information to the terminal device for confirmation, and the user gives feedback according to the confirmation information received by the terminal device. After receiving the feedback information, the Bluetooth lock unlocks based on the unlocking command triggered by the preset key, and the security is further improved.

In this embodiment, after the terminal device passes the verification, the Bluetooth lock can determine the distance to the terminal device based on the Bluetooth signal. When the above distance does not exceed the preset distance, the Bluetooth lock unlocks upon receiving the unlocking command triggered based on the preset key. When the distance of the above device exceeds the preset distance, the Bluetooth lock can send confirmation information to the terminal device for confirmation, and the user gives feedback according to the confirmation information received by the terminal device. After receiving the feedback information, the Bluetooth lock unlocks based on the unlocking command triggered by the preset key, so as to further improve the security.

In addition, the embodiment of the present application also proposes a storage medium on which a Bluetooth intelligent unlocking program is stored. When the Bluetooth intelligent unlocking program is executed by the processor, operations of the Bluetooth intelligent unlocking method described above are realized.

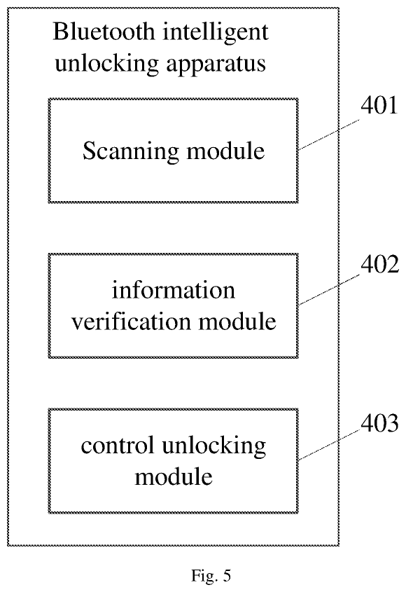

Referring to FIG. 5, FIG. 5 is a structural block diagram of the first embodiment of the Bluetooth intelligent unlocking device of the present application.

As shown in FIG. 5, the Bluetooth intelligent unlocking device proposed in the embodiment of the present application includes:
a scanning module 401 for scanning terminal devices within a preset range based on a Bluetooth signal, and determining whether there is a terminal device according to a scanning result;
an information verification module 402 for in responding to that there is a terminal device, obtaining device information of the terminal device and verifying the device information;
an unlocking control module 403 for in responding to that the device information is validated, unlocking a Bluetooth lock upon receiving an unlocking command triggered based on a preset key.

In the present application, the Bluetooth module is controlled to be in the low-power broadcasting state within the preset range, and the Bluetooth lock scans based on the Bluetooth signal to determine whether there is a terminal device within the preset range. When the Bluetooth lock is not scanned by the terminal device within the preset range, it indicates that there is no terminal device within the preset range. At this time, the indicator of the prompt module flashes slowly at a certain time interval. If the Bluetooth lock is scanned by the terminal device within the preset range, it indicates that there is a terminal device within the preset range, and the Bluetooth lock can obtain the device information of the above terminal device, then verify whether the device information belongs to the device information database based on the device information database. When the device information of the terminal device belongs to the device information database of the Bluetooth lock, the prompt light of the prompt module is changed to be always on. The user can touch the preset key on the Bluetooth lock to trigger the unlocking command, and then the Bluetooth lock is adjusted to an unlocked state. Thus, when there is a terminal device within the preset range, the present application unlocks based on the unlocking command triggered by the preset key, and the user does not need to unlock through the app of the mobile phone and the user experience is improved. Further, considering that the Bluetooth lock needs to add a paired device, upon determining that the device information of the above terminal device does not belong to the device information database, the user can click the Bluetooth device name corresponding to the Bluetooth lock in the pairing list, which indicates that the terminal device has a pairing requirement at this time. At this time, a pairing window can be popped up on the display screen of the terminal device for the user to input the pairing password. After the user inputs the pairing password, the terminal device sends the pairing password to the Bluetooth lock for verification; After verifying that the pairing password is the preset password, the Bluetooth lock obtains the device information of the above terminal device, and obtains the number of pieces of device information stored in the information base. When the number of pieces of device information stored in the information base does not exceed the preset number, it means that the device information database can store more device information at this time, and the Bluetooth lock stores the device information of the terminal device in the device information database. When the number of pieces of the device information in the device information database reaches the preset number, the Bluetooth lock can obtain the storing timestamp corresponding to each piece of device information in the device information database, select the earliest stored device information in the device information database according to the storing timestamps, and replace the earliest stored device information with the device information of the terminal device. Thus, the operation efficiency and the security are both improved. Furthermore, after the terminal device passes the verification, the Bluetooth lock can determine the distance to the terminal device based on the Bluetooth signal. When the distance does not exceed a preset distance, the Bluetooth lock unlocks upon receiving the unlocking command triggered based on the preset key. When the distance exceeds the preset distance, the Bluetooth lock can send confirmation information to the terminal device for confirmation, and the user gives feedback according to the confirmation information received by the terminal device. Upon receiving the feedback information, the Bluetooth lock unlocks based on the unlocking command triggered by the preset key, and the security is further improved.

Other embodiments or specific implementation methods of the Bluetooth intelligent unlocking device of the present application can refer to the above method embodiments, which will not be repeated here.

It should be noted that herein the terms “include”, “comprise” or any other variation thereof are intended to cover nonexclusive inclusion, so that a process, method, article or system including a series of elements includes not only those elements, but also other elements not explicitly listed, or elements inherent in such a process, method, article or system. Without further restrictions, the element defined by the statement “including a . . . ” does not exclude the existence of other identical elements in the process, method, article or system including the element.

The above serial number of the embodiment of the present application is only for description and does not represent the advantages and disadvantages of the embodiment.

Through the description of the above embodiments, those skilled in the art can clearly understand that the above embodiment method can be realized by means of software and a necessary general hardware platform. Of course, it can also be realized by hardware, but in many cases, the former is better. Based on this understanding, the technical solution of the present application, in essence or the part that contributes to the related art, can be embodied in the form of a software product, which is stored in a storage medium (such as a read-only memory/random access memory, a magnetic disc, an optical disc), a plurality of commands are included to enable a terminal device (which can be a mobile phone, a computer, a server, an air conditioner, or a network device) to execute the method described in various embodiments of the present application.

The above is only the preferred embodiment of the present application and does not limit the claimed scope of the present application. All equivalent structure or process transformations made by using the contents of the description and attached drawings of the present application, or any direct or indirect application in other relevant technical fields, are similarly included in the claimed scope of the present application.

1. A Bluetooth intelligent unlocking method, comprising:
scanning terminal devices within a preset range based on a Bluetooth signal, and determining whether there is a terminal device according to a scanning result;
in responding to that there is a terminal device, obtaining device information of the terminal device and verifying the device information; and
in responding to that the device information is validated, unlocking a Bluetooth lock upon receiving an unlocking command triggered based on a preset key.

2. The Bluetooth intelligent unlocking method according to claim 1, wherein the obtaining the device information of the terminal device and verifying the device information comprises:
obtaining the device information of the terminal device; and
verifying whether the device information belongs to a device information database, wherein the device information database stores device information of paired terminal devices within a preset time period.

3. The Bluetooth intelligent unlocking method according to claim 1, after the obtaining the device information of the terminal device and verifying the device information, further comprising:
in responding to that the device information does not belong to the device information database, receiving a Bluetooth pairing request of the terminal device based on the Bluetooth signal;
obtaining a pairing password carried by the Bluetooth pairing request and verifying the pairing password; and
in responding to that the pairing password is validated, establishing a Bluetooth connection with the terminal device, and storing the device information of the terminal device in the device information database.

4. The Bluetooth intelligent unlocking method according to claim 3, wherein the in responding to that the pairing password is validated, establishing the Bluetooth connection with the terminal device and storing the device information of the terminal device in the device information database comprises:
establishing the Bluetooth connection with the terminal device and obtaining the device information of the terminal device in responding to that the pairing password is verified as a preset password;
obtaining a number of pieces of device information in the device information database; and
storing the device information of the terminal device in the device information database in responding to that the number does not exceed a preset number.

5. The Bluetooth intelligent unlocking method according to claim 4, after the obtaining the number of pieces of device information in the device information database, further comprising:
obtaining a storing timestamp corresponding to each piece of device information in the device information database in responding to that the number reaches the preset number;
determining earliest stored device information according to an order of storing timestamps; and
replacing the earliest stored device information with the device information of the terminal device.

6. The Bluetooth intelligent unlocking method according to claim 1, wherein the in responding to that the device information is validated, unlocking the Bluetooth lock upon receiving the unlocking command triggered based on the preset key comprises:
in responding to that the device information is validated, determining whether a distance between the Bluetooth lock and the terminal device exceeds a preset distance based on the Bluetooth signal; and
in responding to that the distance does not exceed the preset distance, unlocking the Bluetooth lock upon receiving the unlocking command triggered based on the preset key.

7. The Bluetooth intelligent unlocking method according to claim 6, after the in responding to that the device information is validated, determining whether the distance between the Bluetooth lock and the terminal device exceeds the preset distance based on the Bluetooth signal, further comprising:
in responding to that the distance exceeds the preset distance, sending confirmation information to the terminal device for unlocking confirmation according to the unlocking command; and
upon receiving confirmation information fed back by the terminal device, unlocking the Bluetooth lock based on the unlocking command triggered by the preset key.

8. A Bluetooth intelligent unlocking device, comprising a memory, a processor and a Bluetooth intelligent unlocking program stored in the memory and executable by the processor, the Bluetooth intelligent unlocking program is configured to realize operations of the Bluetooth intelligent unlocking method according to claim 1.

9. A non-transitory storage medium storing a Bluetooth intelligent unlocking program, when the Bluetooth intelligent unlocking program is executed by a processor, operations of the Bluetooth intelligent unlocking method according to claim 1 are realized.
